(19) United States
(12) Patent Application Publication
(10) Pub. No.: US 2003/0038608 A1
(43) Pub. Date: Feb. 27, 2003

(54) Device for controlling a hydraulic actuator

(76) Inventor: Alexander Meisselbach, Rieneck (DE)

Correspondence Address: Martin A Farber, Suite 473, 866 United Nations Plaza, New York, NY, 10017, US

(21) Appl. No.: 10/221,123

(22) PCT Filed: Feb. 14, 2001
(86) PCT No.: PCT/EP01/01617

(30) Foreign Application Priority Data
Mar. 15, 2000 (DE) 10012409.7

(51) Int. Cl. B60T 11/10; F15B 21/08

(52) U.S. Cl. 318/568.16; 188/151 R; 192/85 R; 91/35

(57) ABSTRACT

In a device for controlling a hydraulic actuator having an electrically actuated valve which controls the flow of pressure medium to and from the actuator, a controller for the position of the valve piston is integrated in the housing of the valve or arranged on the latter in a housing of its own. In order additionally to integrate axial functionality into a device of this type, a second controller, provided for controlling the pressure or the quantity of the pressure medium fed to the actuator, is arranged in the same housing as the controller for the position of the valve piston. Devices of this type are used for example in machine tools.

The invention relates to a device for controlling a hydraulic actuator having an electrically actuated valve which controls the flow of the pressure medium to and from the actuator, having a controller for the position of the valve piston integrated in the housing of the valve or held on the latter in a housing of its own.

A device of this type having an electrically actuated hydraulic valve is known from DE 195 30 935 C2. A displacement pickup for the position of the valve piston converts the position of the valve piston into an electrical signal, which is fed as an actual value to a position controller. The controller for the position of the valve piston is arranged in a housing of its own, which is held on the housing of the valve. The controller makes the valve piston follow a setpoint positional value, which is fed to the controller as an electrical input variable, for example in the form of a voltage. The position of the valve piston determines the size of the passage cross section of the valve. The position of the valve piston is therefore a measure of the passage cross section of the valve. With valves of this type, the flow of pressure medium to and from an actuator, for example a hydraulic cylinder, is controlled. For controlling the movement of the actuator, the pressure of the pressure medium fed to the actuator is sensed, converted into an electrical variable and, taking into account setpoint inputs of a higher-level control, the latter is processed in control circuits arranged separately from the valve to form a setpoint value for the controller integrated in the valve for the position of the valve piston. In the case of arrangements of this type, testing the functional capability is only possible after the individual components required for the operation of the actuator have been fitted. Devices of this type are installed for example in machine tools. If the installation takes place at the premises of the machine manufacturer, staff with special knowledge in the area of use of hydraulic components are required—to avoid instances of wrong operation.

The invention is based on the object of providing a device of the type stated at the beginning in which axial functionality is additionally integrated.

This object is achieved by the features characterized in claim 1. The invention makes it possible to deliver already pretested units which only require the hydraulic and electrical supply lines to be connected to them during installation and which are to be connected with a higher-level control via signal lines.

Advantageous developments of the invention are characterized in the subclaims. The arrangement of pressure sensors in the region of the output connections of the valve, that is in the region of the connections via which the connection of the valve to the actuator takes place, together with the controller provided in addition to the controller for the position of the valve piston, makes it possible to control the pressure and/or quantity of the pressure medium fed to the actuator. The quantity of the pressure medium fed to the actuator is in this case determined in an advantageous way from the pressures in the region of the output connections and from the position of the valve piston, which is a measure of the passage cross section. A computing circuit provided for this purpose is advantageously arranged in the same housing as the controller for the position of the valve piston. When controlling the pressure and quantity of the pressure medium fed to the actuator, the smaller of the manipulated variables for pressure and quantity in each case is fed as a setpoint value to the controller for the position of the valve piston. The minimum-value selection circuit provided for this purpose is likewise arranged in the same housing as the controller for the position of the valve piston. Instead of the manipulated variable of a controller for the quantity of the pressure medium fed to the actuator, a corresponding external manipulated variable may also be fed to the minimum-value selection circuit. The design of the controller for the position of the valve piston as an analog controller permits rapid controlling of the position of the valve piston. The design of the further, higher-level controller as a digital controller allows the parameters of the controller to be set by digital control signals in a simple way. In this case, the functions of a plurality of controllers can be realized by one microprocessor. The use of digital controllers permits simple adjustment of the parameters by external control signals of a higher-level control, for example a machine control. If the control signals are fed via a field-bus system, only little outlay is required for the cabling between the higher-level control and the hydraulic valve. Allocating the electrical components of the analog controller for the position of the valve piston to a first printed circuit board and the components of the further controllers and the components for the bus coupling to a second printed circuit board allows easy adaptation of the electronics to different tasks, since only the second printed circuit board has to be selected to correspond to the specific task.

The invention is explained below more specifically with its further details on the basis of an exemplary embodiment represented in the drawings, in which:

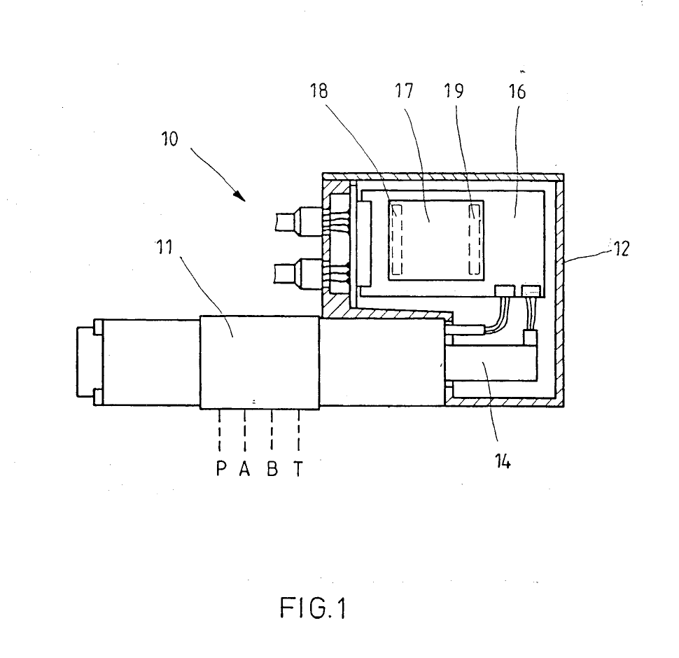

FIG. 1 shows the view of a hydraulic valve with a housing held on the latter for receiving an electrical circuit in a partially sectioned representation and

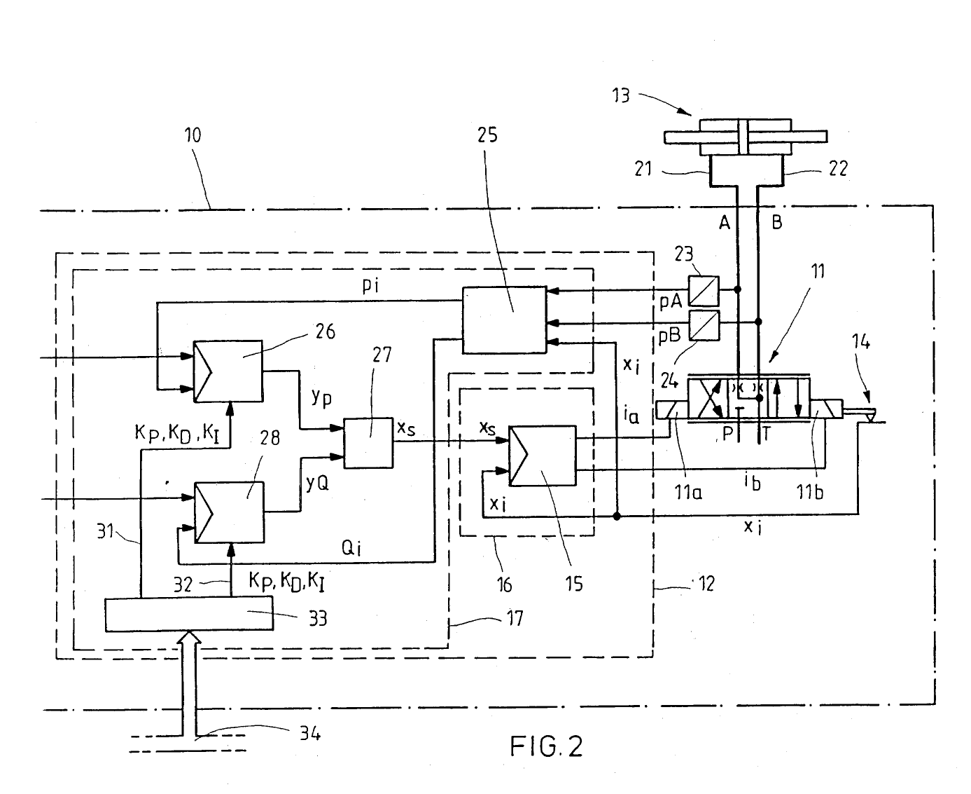

FIG. 2 shows the block diagram of a device according to the invention for controlling a hydraulic actuator with an actuator connected to the device.

FIG. 1 shows the view of a device 10 for controlling a hydraulic actuator. A housing 12 is held on a hydraulic valve 11. The valve 11 is represented as seen from the side. The valve 11 controls the flow of pressure medium from a pump to a hydraulic actuator and from the latter back to a tank. In the exemplary embodiment, the actuator is a hydraulic cylinder, which in FIG. 2 is represented as a synchronous cylinder 13. However, a differential cylinder or a hydraulic motor may also serve as the actuator. The hydraulic connections of the valve 11 are denoted by P for the pump connection, by T for the tank connection and by A and B for the connections of the synchronous cylinder 13. A displacement pickup 14 for the position x of the valve piston protrudes into the housing 12. The displacement pickup 14 converts the position x of the valve piston into an electrical signal xi, which is fed as an actual value to a controller 15 represented in FIG. 2. The components of the controller 15 are arranged on a first printed circuit board 16, which is held in the housing 12. Further components are arranged on a second printed circuit board 17, which is mechanically held on the first printed circuit board 16 by means of plug-in connections 18 and 19. The plug-in connections 18 and 19 serve both for the electrical connection of the printed circuit board 16 to the printed circuit board 17 and for the mechanical connection of the printed circuit boards 16 and 17. This measure allows simple adaptation of the device 10 according to the invention to different tasks by exchanging the printed circuit board 17.

FIG. 2 shows the block diagram of the device 10 represented in FIG. 1 for controlling the synchronous cylinder 13. In this case, the same designations as in FIG. 1 are used for the same components. The controller 15 for the position x of the valve piston of the valve 11 is fed as input signals the output signal xi of the displacement pickup 14, as an actual value, and a setpoint value xs. The output stage of the controller 15 feeds to the coils 11a and 11b of the valve 11 the currents ia and ib, respectively, which serve as a manipulated variable and deflect the valve piston in accordance with the system deviation and the response of the controller 15 in such a way that the valve piston assumes the position predetermined by the signal xs. The connections A and B of the valve 11 are connected to the synchronous cylinder 13 via hydraulic lines 21 and 22, respectively. A pressure sensor 23 senses the pressure in the region of the connection A of the valve 11 and feeds a signal pA corresponding to this pressure to a computing circuit 25. A further pressure sensor 24 senses the pressure in the region of the connection B of the valve 11 and feeds a signal pB corresponding to this pressure to the computing circuit 25. The pressure sensors 23 and 24 are component parts of the device 10. In addition to the signals pA and pB, the actual value xi of the position of the valve piston is fed to the computing circuit 25. The computing circuit 25 forms from the weighted pressure differential of the signals pA and pB an actual pressure value pi. The actual pressure value pi is fed together with a setpoint pressure value ps to a pressure controller 26. The pressure controller 26 forms from these signals in accordance with its response a manipulated variable yp. The manipulated variable yp is fed together with a manipulated variable yQ, which limits the quantity of the pressure medium fed to the synchronous cylinder 13, to a minimum-value selection circuit 27. This circuit feeds the smaller of the signals fed to it to the controller 15 as setpoint value xs. The manipulated variable yQ may be the output signal of a quantity controller 28—as represented in FIG. 2—or—if no quantity controller is provided—a corresponding signal fed to the device 10 from the outside. The quantity controller 28 represented in FIG. 2 is fed an external setpoint quantity value Qs and an actual quantity value Qi determined by the computing circuit 25 from the signals pA, pB and xi.

In order that the actual value of the position of the valve piston follows its setpoint value as quickly as possible, the controller 15 is designed as an analog controller. The pressure controller 26 and—if present—the quantity controller 28 are designed as microprocessor-controlled digital controllers. As a result, it is possible in a simple way to set the parameters of the controllers 26 and 28 even during operation by external control signals. If the controllers have PID action, the parameters are the gain factors KP, KD and KI, with KP denoting the gain factor of the proportional component (P component), KD denoting the gain factor of the differentiating component (D component) and KI denoting the gain factor of the integrating component (I component). The control signals for the parameters are fed to the controllers 26 and 28 via electrical lines 31 and 32, respectively. If the capacity utilization of the microprocessor allows, it can take over the functions of the computing circuit 25 and the minimum-value selection circuit 27. The device 10 is coupled to the field bus 34 via an interface 33. The interface 33 takes from the field bus 34 the data intended for the device 10 and converts them into a form suitable for the processing within the device 10. The communication between a higher-level machine control (not represented in the figures) and further devices for controlling hydraulic actuators takes place via the field bus 34.

The components of the analog controller 15 provided for controlling the position of the valve piston are arranged on the printed circuit board 16. The components of the digital controllers 26 and 28, of the computing circuit 25 and of the minimum-value selection circuit 27 and also of the interface 33 for the coupling to the field bus 34 are arranged on the printed circuit board 17. Since the valve 11 with the controller 15 adapted to the properties of the valve 11 are always the same, for the various applications, all that is necessary is to mount on the printed circuit board 16 the printed circuit board 17 with the controllers for pressure and quantity adapted to the hydraulic actuator respectively used.

In FIG. 1, a separate housing 12 for receiving the printed circuit boards 16 and 17 which bear the electronic circuits is held on the valve 11. However, it is also possible to design the housing of the valve in such a way that the printed circuit boards 16 and 17 carrying the electronic circuits are held directly in the housing of the valve. In this case, it is advantageous to provide dividing walls in the housing of the valve, which prevent pressure medium from getting into the region in which the printed circuit boards are held.

1. A device for controlling a hydraulic actuator having an electrically actuated valve which controls the flow of the pressure medium to and from the actuator, having a controller for the position of the valve piston integrated in the housing of the valve or held on the latter in a housing of its own, characterized in that a second controller (26), provided for controlling the pressure (pA, pB) or the quantity (Q) of the pressure medium fed to the actuator (13), is arranged in the same housing (12) as the controller (15) for the position (x) of the valve piston.

2. The device as claimed in claim 1, characterized in that the valve (11) is provided with a pressure sensor (23 or 24), which senses the pressure (pA or pB) in the region of an outlet connection (A or B) of the valve (11), in that the second controller (26) is designed as a pressure controller and in that the output signal (pA or pB) of the pressure sensor (23 or 24) is fed to the second controller (26) as an actual pressure value (pi).

3. The device as claimed in claim 1 or claim 2, characterized in that the valve (11) is provided with two pressure sensors (23, 24), which sense the pressures (pA, pB) in the region of the output connections (A, B) of the valve (11), in that the output signals (pA, pB) of the pressure sensors (23, 24) are fed to a computing circuit (25) and in that the computing circuit (25) is arranged in the same housing (12) as the controller (15) for the position (x) of the valve piston.

4. The device as claimed in claim 3, characterized in that the computing circuit (25) processes the signals (pA, pB) fed to it to form an actual pressure value (pi) for the pressure control.

5. The device as claimed in claim 4, characterized in that the manipulated variable (yp) of the pressure controller (26) and a setpoint value (yQ) for the position (x) of the valve piston, limiting the quantity of the pressure medium fed to the actuator (13), are fed to a minimum-value selection circuit (27) and in that the output variable of the minimum-value selection circuit (27) is fed as a setpoint value (xs) to the controller (15) for the position (x) of the valve piston.

6. The device as claimed in claim 3, characterized in that the computing circuit (25) is additionally fed the actual value (xi) of the position of the valve piston and in that the computing circuit (25) processes the signals (pA, pB, xi) fed to it to form an actual quantity value (Qi) for the quantity control.

7. The device as claimed in claims 5 and 6, characterized in that a controller (28) for controlling the quantity (Q) of the pressure medium fed to the actuator (13) is arranged in the same housing (12) as the controller (15) for the position (x) of the valve piston and in that the manipulated variables (yp, yQ) of the two controllers (26, 28) are fed to the minimum-value selection circuit (27).

8. The device as claimed in one of the preceding claims, characterized in that the controller (15) for the position (x) of the valve piston is designed as an analog controller and in that the further controllers (26, 28) are designed as microprocessor-controlled digital controllers.

9. The device as claimed in claim 8, characterized in that the parameters (KP, KD, KI) of the further controllers (26, 28) can be set by external control signals.

10. The device as claimed in claim 9, characterized in that the setting of the parameters of the further controllers (26, 28) takes place by digital control signals.

11. The device as claimed in claim 10, characterized in that the feeding of the digital control signals takes place via a field-bus system (34).

12. The device as claimed in claim 11, characterized in that the components of the controller (15) for the position (x) of the valve piston are arranged on a first printed circuit board (16), in that the components of the further controllers (26, 28) and also of the bus coupling are arranged on a second printed circuit board (17) and in that the second printed circuit board (17) is held on the first printed circuit board (16) by means of a plug-in connection (18, 19).
